(19) United States
(12) Patent Application Publication
(10) Pub. No.: US 2003/0138027 A1
(43) Pub. Date: Jul. 24, 2003

(54) Clinical temperature test instrument

(75) Inventor: Chu-Yih Yu, San Chung City (TW)

Correspondence Address: BRUCE H. TROXELL, Suite 1404, 5205 Leesburg Pike, Falls Church, VA, 22041, US

(73) Assignee: Mesure Technology Co., Ltd.

(21) Appl. No.: 10/050,122

(22) Filed: Jan. 18, 2002

(51) Int. Cl. G01K 7/00

(52) U.S. Cl. 374/183

(57) ABSTRACT

A clinical temperature test instrument includes disposable temperature test strips adapted for detecting the temperature of a person's body, and a strip reader adapted for reading the temperature level of each temperature test strip used, each temperature test strip having a temperature induction crystal embedded in a front side thereof and adapted for detecting the temperature level of the body of the person by contact, two terminals extended from a rear side thereof for output of detection signal from the temperature induction crystal to the strip reader, and lead wires connected between the ends of the temperature induction crystal and the terminals.

### BACKGROUND OF THE INVENTION

1. Field of the Invention

The present invention relates to devices for measuring the body temperature of a person and, more particularly, to a clinical temperature test instrument, which eliminates interference of external factors, and achieve rapid and accurate examination.

2. Description of the Related Art

Regular body temperature measuring instruments have two types, namely, the contact type and the non-contact type. A gun-base infrared temperature sensor is a non-contact type body temperature measuring instrument. A mercury or electronic thermometer is a contact type body temperature measuring instrument. When measuring the body temperature of a person with a gun-base infrared temperature sensor, the surroundings of the external auditory canal (the hair of the tragus, residual ear wax, tophus, etc.) may affect the test result. Therefore, the test result obtained from a gun-base infrared temperature sensor is simply used as a reference value, but not accurately indicative of the real body temperature. A mercury thermometer must be properly disposed of after its service because mercury is severely harmful to the environment. When using an electronic thermometer to measure the body temperature of a person, the test tip of the electronic thermometer must be kept in close contact with the test body for a certain length of time, for example, about 1˜2 minutes so that accurately test value can be obtained. Because the shell of the electronic thermometer absorbs heat from the test tip, it takes time to let the temperature level of the test tip be in balance with the body temperature of the test body.

### SUMMARY OF THE INVENTION

The present invention has been accomplished under the circumstances in view. It is one object of the present invention to provide a clinical temperature test instrument, which rapidly achieves an accurate body temperature examination. It is another object of the present invention to provide a clinical temperature test instrument, which eliminates possible contamination. According to the present invention, the clinical temperature test instrument is comprised of a plurality of disposable temperature test strips adapted for detecting the temperature of a person's body, and a strip reader adapted for reading the temperature level of each temperature test strip used. Each temperature test strip has a temperature induction crystal embedded in a front side thereof and adapted for detecting the temperature level of the body of the person by contact, two terminals extended from a rear side thereof for output of detection signal from the temperature induction crystal to the strip reader, and lead wires connected between the ends of the temperature induction crystal and the terminals. The thickness of the temperature test strips is about 0.3 mm that enables the temperature of the test body to be quickly transmitted to the temperature induction crystal. Because the temperature test strips are disposable, possible contamination is eliminated.

### BRIEF DESCRIPTION OF THE DRAWINGS

FIG. 1 is a perspective view of a temperature test strip constructed according to the present invention.

FIG. 2 is a side plain view of the temperature test strip shown on FIG. 1.

FIG. 3 illustrates a temperature test strip inserted into a strip reader according to the present invention.

FIG. 4 is a perspective view of pocket-sized body temperature recorder according to the present invention.

FIG. 5 illustrates a daily base body temperature curve displayed on the display of the pocket-sized body temperature recorder shown on FIG. 4.

### DETAILED DESCRIPTION OF THE PREFERRED EMBODIMENT

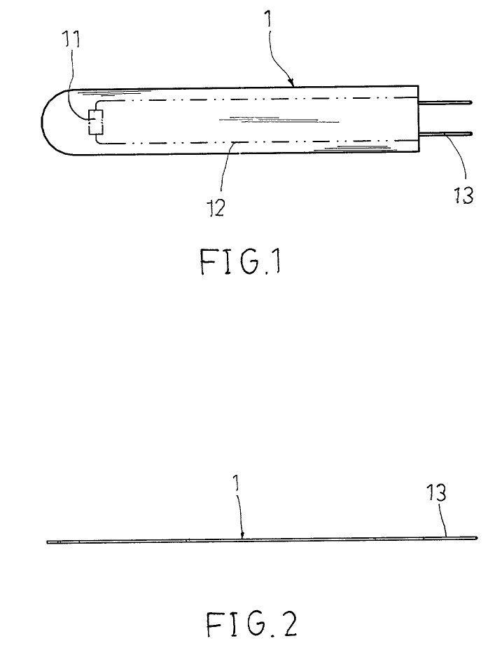

Referring to FIGS. 1 and 2, temperature test strip 1 is a long, narrow, flat member of thickness about 0.3 mm that can be maintained in close contact with the surface of the test body and quickly heated by the test body to the saturated status within a short length of time, for example, about 3 seconds. The temperature test strip 1 has a temperature induction crystal 11 embedded in the front side thereof, two terminals 13 extended from the rear side thereof, and lead wires 12 connected between the two opposite ends of the temperature induction crystal 11 and the terminals 13.

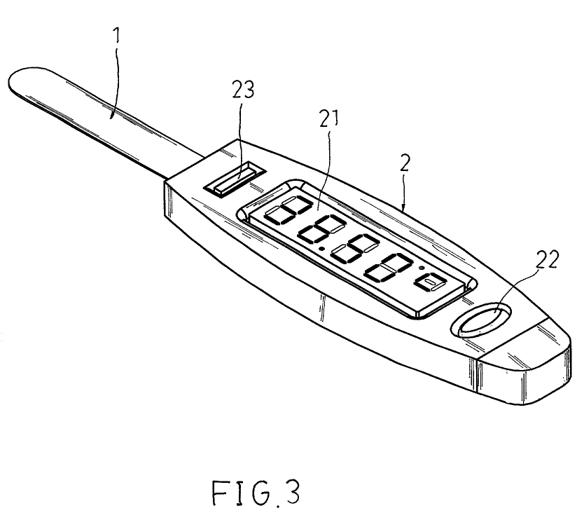

Referring to FIG. 3, after each test, the temperature test strip 1 is inserted into the strip reader, referenced by 2, for reading the test result. The strip reader 2 is an electronic apparatus comprising a display 21, a power switch 22, and a release 23. Upon insertion of the test strip 1 into the strip reader 2, the test strip 1 is automatically locked, keeping the terminals 13 in close contact with respective contacts of the internal circuit of the strip reader 2. When switched on the power switch 22, the internal temperature reading circuit of the strip reader 2 immediately reads the temperature level of the temperature induction crystal 11, and shows the reading result on the display 21. Because the internal temperature reading circuit of the strip reader 2 is of the known art and not within the scope of the present invention, not further detailed description on the internal temperature reading circuit is needed. Further, because the test strip 1 is inexpensive to manufacture, it is thrown away after use, preventing possible contamination.

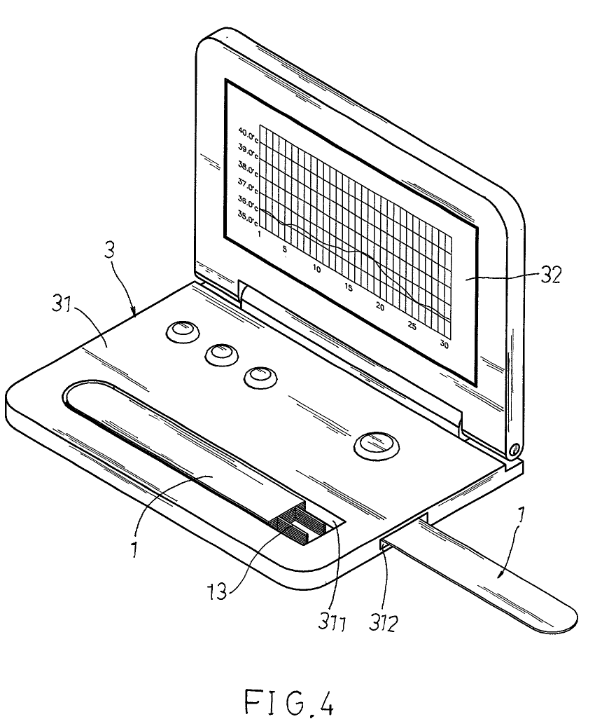

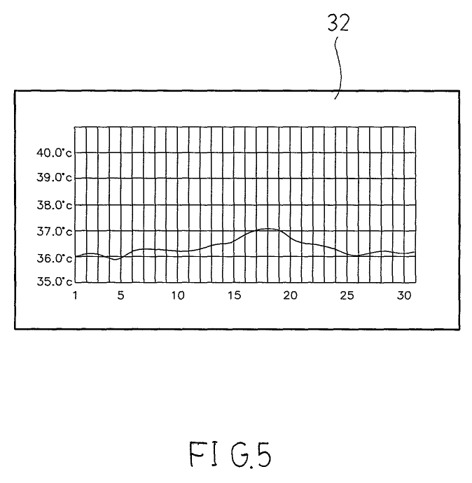

Referring to FIGS. 4 and 5, a pocket-sized body temperature recorder 3 may be used with test strips 1. The pocket-sized body temperature recorder 3 comprises a recorder body 31, and a display panel 32 hinged to the recorder body 31. The recorder body 31 comprises a receiving chamber 311 adapted for receiving test strips 1, and an insertion slot 312 into which the tested test strip 1 is inserted for reading the test result. The recorder body 31 records the test result of each test, and displays on the display panel 32 the test result of each test and the recorded test results.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A clinical temperature test instrument comprising a plurality of temperature test strips adapted for detecting the temperature of a person's body, and a strip reader adapted for reading the temperature level of each of the temperature test strips used, said temperature test strips each comprising a temperature induction crystal embedded in a front side thereof and adapted for detecting the temperature level of the body of the person to which the temperature test strip is attached, two terminals extended from a rear side thereof for output of detection signal from said temperature induction crystal to said strip reader, and lead wires connected between two opposite ends of said temperature induction crystal and said terminals.

2. The clinical temperature test instrument as claimed in claim 1, wherein said strip reader has a test strip insertion slot for the insertion of the terminals of the tested temperature test strip for reading the test result.

3. The clinical temperature test instrument as claimed in claim 1, wherein said strip reader is a pocket-sized body temperature recorder adapted to read, record, and display the temperature level of each of the temperature test strips used, said pocket-sized body temperature recorder having a receiving chamber adapted for receiving the temperature test strips not used.
